(19) United States
(12) Patent Application Publication
(10) Pub. No.: US 2011/0051716 A1
(43) Pub. Date: Mar. 3, 2011

(54) TV ACTING AS POTS PHONE SWITCH

(75) Inventors: Peter Shintani, San Diego, CA (US); Koichi Oshima, San Diego, CA (US); Toshiyuki Suzuki, Tokyo (JP)

(73) Assignees: SONY CORPORATION; SONY ELECTRONIC INC.

(21) Appl. No.: 12/553,349

(22) Filed: Sep. 3, 2009

(51) Int. Cl. H04L 12/66

(52) U.S. Cl. 370/352

(57) ABSTRACT

A TV receives IP calls and POTS calls. When a POTS call is received the TV passively passes the call to a non-IP phone, and when an IP call is received the TV processes the IP packets as appropriate for the non-IP phone and passes the call to the phone. The non-IP phone can also signal using a special code a desired to place an IP call, with the signals from the phone being rendered into IP packets by the TV. In this way, a non-IP phone may be used to place and receive both POTS calls and IP-based calls.

### FIELD OF THE INVENTION

The present invention relates generally to configuring TVs to act as Internet Protocol (IP) phone relays for plain old telephone system (POTS) telephones.

### BACKGROUND

There are several IP-based phone services available to the consumer. As recognized herein, a drawback of such services is that some knowledge of computers is typically required for setup. Consequently, many customers are hesitant to use IP based phone services due to the complexity.

Present principles understand that addressing the above issue by integrating IP phone functionality into a standalone POTS phone is less than optimum. This is because such standalone POTS phones must still be connected to the Internet either wired or wirelessly. Furthermore, the more preferred wireless Internet connection requires a relatively more complex set up than a wired connection.

### SUMMARY OF THE INVENTION

Present principles address the shortcomings noted above and provide an easy to set up and use internet connection-based phone service system that is integrated into a display for seamless interface with a standard non-IP phone.

Accordingly, a system includes a TV display, a TV processor associated with the TV display, and a TV tuner through which TV signals may be presented on the TV display. The TV processor causes plain old telephone system (POTS) calls to be passed to a non-IP phone and also causes IP-based calls to be sent to the non-IP phone.

The TV itself thus may receive the POTS calls and the IP-based calls. The TV may be programmed with voice over IP capability including an IP phone number which may be called by outside callers.

In some examples, when the TV processor detects an incoming telephone call, it determines whether the call is IP-based or a POTS call. If an incoming call is an IP-based call a POTS connection can be disconnected from an output port of the TV and if desired an answering machine function implemented by the TV processor so that if a POTS call is received during the IP-based call, the POTS is answered by the answering machine function.

When an incoming call is determined to be an IP-based call the TV processor may cause the TV to present a visual and/or audible message to announce the incoming IP-based call. In any case, the TV does not generate a 90V AC voltage to complete a POTS call to the non-IP phone, but instead advantageously provides only a 24V˜48V DC voltage for a local loop current to the non-IP phone.

In another aspect, a method includes receiving, at a TV, Internet Protocol (IP) calls and plain old telephone system (POTS) calls. When a POTS call is received, the TV is used to passively pass the POTS call to a non-IP phone. When an IP call is received, the TV is used to process IP packets in the IP call as appropriate for the non-IP phone. The processed IP call is then passed to the non-IP phone.

In another aspect, a system includes a TV display, a TV processor associated with the TV display, and a TV tuner through which TV signals may be presented on the TV display. The TV processor causes plain old telephone system (POTS) call signals from a non-IP phone to be sent to a recipient in POTS format or IP format responsive to a format selection signal from the non-IP phone.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a flow chart of example logic for receiving a call;

FIG. 3 is a flow chart of example logic for placing a call;

FIG. 4 is an example incoming call screen shot; and

FIG. 5 is an example outgoing call screen shot.

### DETAILED DESCRIPTION OF THE PREFERRED EMBODIMENT

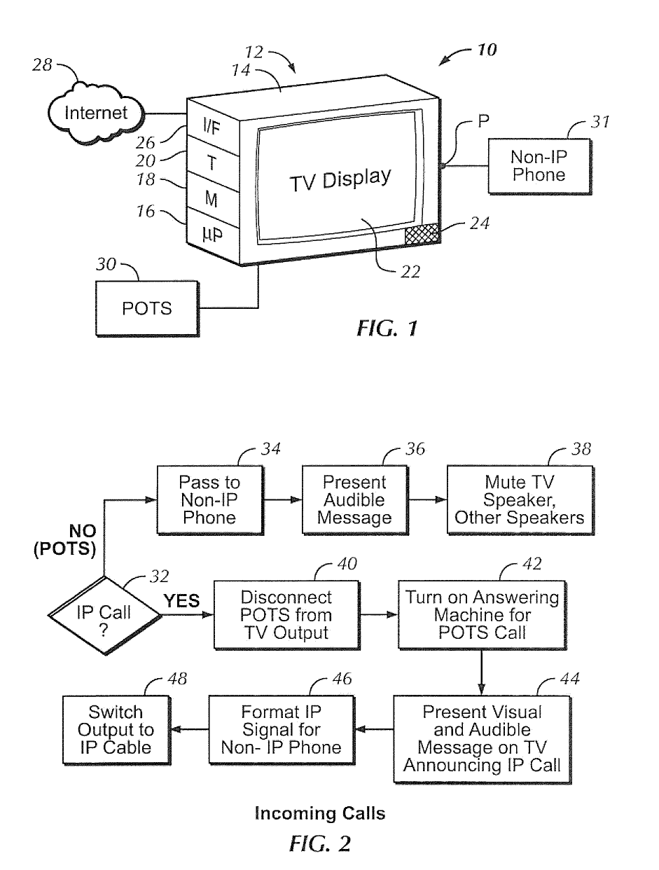

Referring initially to FIG. 1, a system 10 includes a TV 12 defining a TV chassis 14 holding a TV processor 16 accessing a computer readable storage medium 18, such as solid state and/or disk-based storage. The storage medium 18 may store data and software executable by the processor 16 for undertaking all or parts of the logic divulged herein for processing telephone calls. The processor 16 typically communicates with a TV tuner 20 in the chassis 14 for presenting TV signals on a display 22 and speaker(s) 24, it being understood that one or more of the components above may alternatively be incorporated in a set-top box that is separate from the chassis 14. The TV 12 may be an analog and/or digital TV with a flat panel (matrix-type) standard definition and/or high definition (HD) display, although other types of displays may be used.

As shown in FIG. 1, the TV 12 can also include an Internet interface 26 such as but not limited to a wired or wireless modem for enabling the processor 16 to communicate with a wide area network such as the Internet 28 through which IP-based voice calls can be communicated. Without limitation the Internet interface 26 may be an Ethernet RJ45 interface or 802.11a/b/g/n interface.

Also, the TV 12 can communicate with the non-IP POTS 30, it being understood that while separate connections are shown for the POTS 30 and Internet 28, the TV 12 may communicate with both using a single input interface. The TV 12 also communicates with a non-IP conventional phone 31, typically located in the same dwelling as the TV 12, over a communication port “P” that may be, e.g., an RJ-11 terminal.

Example incoming call logic may be seen in reference to FIG. 2. The TV 12 can be programmed in the factory with voice over IP capability including an IP phone number which may be called by outside callers, it being understood that the IP phone number in some embodiments may not programmed into the TV until after purchase and IP registration. Specifically, purchase of the TV, the user activates an IP phone service in accordance with IP phone registration policies and procedures known in the art. Also, the POTS line in the dwelling can be connected to the TV so that the TV receives all calls into the dwelling, both IP calls and POTS calls to the non-IP phone 31.

Decision diamond 32 indicates that when the TV processor 16 detects an incoming telephone call, it determines whether the call is IP-based or a POTS call. The determination can be made by simply noting which interface the call arrives at, e.g., an Internet interface (indicating an IP call) or the POTS interface (indicating a POTS call.) Or, the determination can be made by ascertaining whether the accompanying ring tone is 90 volts AC (indicating a POTS call) and/or by determining whether the incoming call contains IP packets, indicating an IP-based call.

If the call is a POTS call the TV 12 in effect functions as a passive connection, passing the POTS call to the non-IP phone 31 at block 34 through, e.g., an RJ-11 connection. If desired, at block 36 an audible call message such as an emulated POTS ring tone can be presented on the speaker 24. Also, if desired at block 38 the TV speaker 24 subsequently can be muted for the duration of the call. The TV 12 can also send a mute signal to other home system components over a home network infrared link or CEC link. It is to be understood that similar muting may be effected for IP-based calls.

In contrast, when an IP-based call is received at decision diamond 32, the logic moves to block 40 to disconnect the POTS line from its output port P. At block 42 if desired the TV can activate an answering machine function which may be implemented in software executed by the TV processor 16 so that if a POTS call is received during the IP-based call, the call can be answered by the answering machine function executed by the TV processor 16, which may store messages on the medium 18. It is to be understood that the inverse may also be used, i.e., if a POTS call is in progress and a new IP call arrives, the IP call is sent to the answering machine function.

Proceeding to block 44, the TV processor 16 can cause the TV 12 to present a visual and/or audible message (on, respectively, the display 22/speaker 24) to announce the incoming IP-based call. The audible message may be without limitation an audible bell tone. At block 46 the IP call data is formatted as appropriate for the non-IP phone 31 and then passed through the port “P” to the phone 31 at block 48. Preferably, the logic of FIG. 2 may be implemented even when the TV/display is in a standby mode. Also, to be eco-friendly, the user could be given an option to enable IP call reception while the TV is in the standby mode, as the assumption is that to enable IP phone capability in the standby mode would require more power. Furthermore, for safety, when there is a loss of power, the POTS pass through remains operational.

It may now be appreciated that because the TV 12 has audio capability, it can easily signal to the user the presence of an incoming call. Hence there is no need for the TV to be able to create the approximately 90V AC voltage to the POTS line to ring the bell on the phone 31 during POTS calls. Instead, the TV 12 need only provide 24V˜48V DC for the local loop current to the phone 31, although the phone 31 may still receive 90 volts AC from the POTS line that the TV passes through.

With more specificity, the pass through POTS line carries the 90V AC which is merely passed by the TV to the phone, so there is no need for the TV itself to generate the 90 VAC. In the case of a DECT phone interface, the TV merely needs to send the Ling command. In the case of an incoming IP call, however, since there is no 90 VAC the TV either generates the 90 VAC ring signal or relies upon the use of an audible tone from the speakers 24 to notify the user that a call was received.

This results in the latter case in a cost savings, since there is no need to include a high voltage AC voltage source in the TV when IP phone connectivity is added.

In communicating with the non-IP phone 31 the TV 12 may use a standard such as the Digital Enhanced Cordless Telecommunications (DECT) standard to signal and then communicate and pass the IP phone call to the non-IP phone 31.

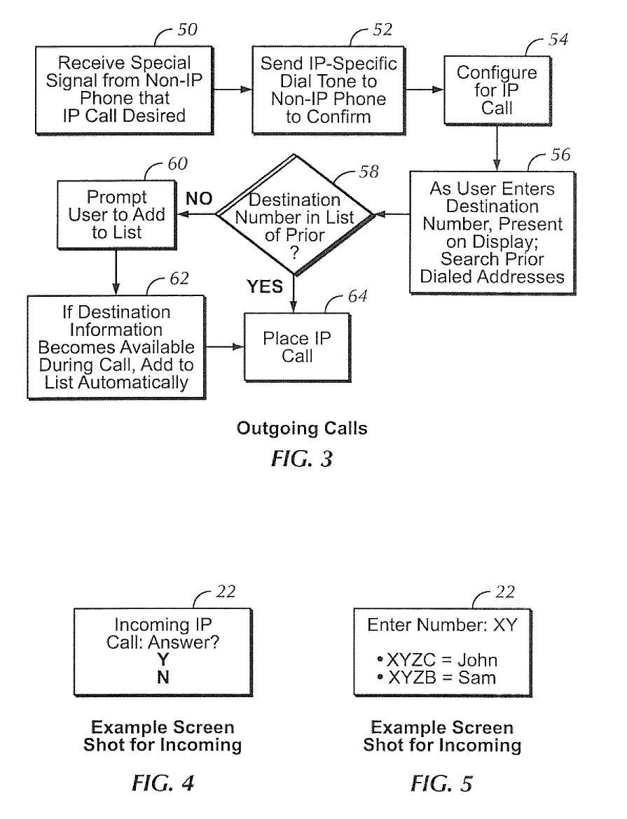

FIG. 3 illustrates example outgoing call logic for IP calls, it being understood that for POTS calls from the phone 31 the phone 31 is simply dialed conventionally and the call passes through the TV 12. At block 50, a special signal is received from the phone 31 indicating a desire to place an IP-based call. The special signal may be a DECT protocol signal or it may be a signal corresponding to user keypad input. For example, a rudimentary code may be used to allow the POTS phone user to signal to the TV via the phone line a desire to activate the IP calling feature of the TV. As a non-limiting illustration, when the user tries to make call, if no prefix is used, the TV 12 assumes a POTS call is intended, whereas if a special prefix such as “47#” is entered on the keypad of the phone 31, the TV 12 will implement IP-based calling.

Assuming an IP call is indicated, at block 52 the TV 12 can send to the phone 31 a distinct dial tone corresponding to IP calling, which is a different tone than that sent for a POTS call. In this way the user can aurally confirm the IP phone mode. The TV 12 then configures itself for an IP call at block 54 by, e.g., translating signals from the phone 31 into IP packets.

Furthermore, once in the IP phone mode, if desired at block 56 as the user enters a phone number the TV 12 can perform a search to confirm the number and name of the called party.

If the number is not found in a list of formerly dialed IP addresses (which may be stored on the medium 18) at decision diamond 58, at block 60 the user can then be prompted to enter information to identify that number and add it to the list. If recipient data becomes available during the call at block 62 via the IP phone system, the TV processor 16 can automatically add it to the list. The IP call is then placed at block 64 to the destination input on the phone 31.

In any case, it will readily be appreciated that as discussed further below the superior graphical capability of the TV 12 can be used to provide an easy to use menu and if necessary, set up menu system. For example, when an incoming call is received, as shown in FIG. 4 the TV display 22 can prompt a user to answer or not. Additional information can be presented such as caller ID on the display 22, which is much easier to view than the typical telephone display.

FIG. 5 shows that when the IP-indicating special code is entered on the phone 31 as discussed above, the TV display 22 can present a prompt to enter a number. In the example shown, “XY” has been entered as a partial entry. As a consequence, available numbers in the list of previously called numbers that begin with “XY” are presented as shown, from which the user can select if desired using, e.g., a TV remote control. Or, the user can simply complete inputting the desired number on the telephone keypad.

If desired, if a quality of service index (such as but not limited to signal to noise ratio, received signal strength, or bit error rate) of an IP-based call drops below a minimum acceptable threshold, the TV can automatically redial the dropped number over the POTS network.

While the particular TV ACTING AS POTS PHONE SWITCH is herein shown and described in detail, it is to be understood that the subject matter which is encompassed by the present invention is limited only by the claims.

What is claimed is:

1. System comprising:
TV display;
TV processor associated with the TV display;
TV tuner through which TV signals may be presented on the TV display; wherein
the TV processor causes plain old telephone system (POTS) calls to be passed to a non-IP phone and also causes IP-based calls to be sent to the non-IP phone.

2. The system of claim 1, wherein the TV receives the POTS calls and the IP-based calls.

3. The system of claim 2, wherein the TV is programmed with voice over IP capability including an IP phone number which may be called by outside callers.

4. The system of claim 2, wherein when the TV processor detects an incoming telephone call, it determines whether the call is IP-based or a POTS call.

5. The system of claim 2, wherein if an incoming call is an IP-based call a POTS connection is disconnected from an output port of the TV.

6. The system of claim 5, wherein the TV activates an answering machine function implemented by the TV processor on the occurrence of at least one of: a POTS call is received during the IP-based call, such that the POTS is answered by the answering machine function; an IP-based call is received during a POTS call, such that the IP-based call is answered by the answering machine function.

7. The system of claim 1, wherein when an incoming call is determined to be an IP-based call the TV processor causes the TV to present a visual and/or audible message to announce the incoming IP-based call.

8. The system of claim 1, wherein the TV does not generate a 90V AC voltage to complete a POTS call to the non-IP phone, the TV providing only a 24V˜48V DC voltage for a local loop current to the non-IP phone.

9. A method comprising:
receiving, at a TV, Internet Protocol (IP) calls and plain old telephone system (POTS) calls;
when a POTS call is received, using the TV to passively pass the POTS call to a non-IP phone;
when an IP call is received, using the TV to process IP packets in the IP call as appropriate for the non-IP phone; and
passing the IP call to the non-IP phone.

10. The method of claim 9, wherein the non-IP phone signals, using a special code, a desired to place an IP call, with voice signals from the phone being rendered into IP packets by the TV, such that a non-IP phone is used to place and receive both POTS calls and IP-based calls.

11. The method of claim 9, wherein the TV includes a TV display, a TV processor associated with the TV display, and a TV tuner through which TV signals may be presented on the TV display, wherein when the TV processor detects an incoming telephone call, it determines whether the call is IP-based or a POTS call.

12. The method of claim 11, wherein the TV determines whether the call is IP-based or a POTS call by determining whether an accompanying ring tone is 90 volts AC, indicating a POTS call, and/or by determining whether the incoming telephone call contains IP packets, indicating an IP-based call.

13. The method of claim 11, wherein if an incoming call is an IP-based call a POTS connection is disconnected from an output port of the TV.

14. The method of claim 13, wherein the TV activates an answering machine function implemented by the TV processor so that if a POTS call is received during the IP-based call, the POTS is answered by the answering machine function.

15. The method of claim 11, wherein when an incoming call is determined to be an IP-based call the TV processor causes the TV to present a visual and/or audible message to announce the incoming IP-based call.

16. The method of claim 9, wherein the TV does not generate a 90V AC voltage to complete a POTS call to the non-IP phone, the TV providing only a 24V˜48V DC voltage for a local loop current to the non-IP phone.

17. The method of claim 9, wherein if a quality of service index of an IP-based call drops below a minimum acceptable threshold, the TV automatically redials, over a POTS network, a number associated with an originator of the IP.

18. System comprising:
TV display;
TV processor associated with the TV display;
TV tuner through which TV signals may be presented on the TV display; wherein
the TV processor causes plain old telephone system (POTS) call signals from a non-IP phone to be sent to a recipient in POTS format or IP format responsive to a format selection signal from the non-IP phone.

19. The system of claim 18, wherein a special code is received from the non-IP phone indicating a desire to place an IP call.

20. The system of claim 19, wherein the special code is generated from user manipulation of a keypad on the non-IP phone.

21. The system of claim 19, wherein in response to the special code the TV 12 sends to the non-IP phone a distinct dial tone corresponding to IP calling, the distinct dial tone being a different tone than that sent for a POTS call.
